(19) United States
(12) Patent Application Publication
(10) Pub. No.: US 2005/0096081 A1
(43) Pub. Date: May 5, 2005

(54) Tunable ground return impedance for a wireless communication device

(76) Inventors: Gregory R. Black, Vernon Hills, IL (US); Chidambaram Shankar, Gurnee, IL (US); Vimalkaushik Natarajan, Grayslake, IL (US); Robert Giometti, Buffalo Grove, IL (US); Leslie Dean Mutz, Vernon Hills, IL (US); Robert Michael Netz, Grayslake, IL (US)

Correspondence Address: MOTOROLA INC, 600 NORTH US HIGHWAY 45, ROOM AS437, LIBERTYVILLE, IL, 60048-5343, US

(21) Appl. No.: 10/698,249

(22) Filed: Oct. 31, 2003

(51) Int. Cl. H04M 1/00

(52) U.S. Cl. 455/550.1; 455/575.1

(57) ABSTRACT

An apparatus (100) and a method (1300) for a wireless portable communication device for tuning ground return impedance based upon its configuration are provided. The wireless portable communication device (100) detects its configuration and provides appropriate impedance for a desired antenna performance for the detected configuration by adjusting a ground return impedance block (114) between a printed circuit board ground (108) and a chassis (112).

### FIELD OF THE INVENTION

The present invention generally relates to a method and an apparatus for tuning impedance, and more specifically to a method and an apparatus for tuning ground return impedance of the apparatus based upon a configuration of the apparatus.

### BACKGROUND OF THE INVENTION

In a wireless portable communication device, an antenna plays an important role in providing reliable communication. As the wireless portable communication device such as a cellular telephone is made smaller, a printed circuit board (“PCB”), which is connected to the antenna and is populated with electronic and mechanical components, also plays a role in enhancing the antenna performance. Often, such cellular telephone includes a plurality of PCBs, and requires individual PCBs to be electrically connected to each other. Once an antenna is selected for a specific wireless portable communication device, the antenna performance is generally made more optimal by matching its impedance to the PCB under a preselected environment. For example, the preselected environment may represent the cellular telephone in a standby mode by itself without any object nearby, in the standby mode in a user's pocket, or in any other typical operating positions. However, as the cellular telephone is used in an environment that is different from the preselected environment, the antenna performance is no longer likely to be optimal, and the performance of the cellular telephone may degrade. For example, the cellular telephone having its antenna performance more optimized for the standby mode in the user's pocket, may suffer in performance once it is in operation and/or is held in the user's hand. Further, today's typical cellular telephone can operate with various attachable accessories, such as headsets, cameras, speakerphones, and Personal Digital Assistants (“PDAs”), and each of these attachable accessories, once the accessory is attached, can affect the antenna performance of the cellular telephone by altering the electrical characteristics of the cellular telephone, such as electrical length or electrical ground of the cellular telephone. For a multi-band cellular telephone, such as a cellular telephone designed to operate in the Global System for Mobile (“GSM”) network having 850 MHz, 900 MHZ, 1800 MHz, and/or 1900 MHz bands, in the Time Division Multiple Access (“TDMA”) network having 850 MHz and 1900 MHz bands, in the Code Division Multiple Access (“CDMA”) network having 850 MHz and 1900 MHz bands, in the Advanced Mobile Phone System (“AMPS”) in addition to any other network, or in any other multi-band and/or multi-mode networks, the antenna performance optimization is further complicated by having to optimize for multiple frequency bands. If the antenna performance is more optimized for a first band, then the antenna performance in a second band is likely to be less optimized than in the first band. Various types of foldable, rotatable, and extendable portable wireless communication devices are also becoming increasingly popular. Each of these types of portable wireless communication devices offers opened and closed positions: the closed position for a compact size for storage while not in use, and the opened position for an extended and more user friendly size when in use. However, if the antenna performance is more optimized for either one of the opened or closed positions, the other position is likely to present a different electrical length or electrical ground plane to the antenna, which is likely to provide a less optimal antenna performance.

### BRIEF DESCRIPTION OF THE DRAWINGS

FIG. 1 is an exemplary block diagram of a wireless portable communication device configured to provide appropriate impedance for a desired antenna performance based upon a configuration of the wireless portable communication device in accordance with the present invention;

FIG. 2 is an exemplary foldable wireless portable communication device in a closed position;

FIG. 3 is an exemplary foldable wireless portable communication device in an opened position;

FIG. 4 is an exemplary rotatable wireless portable communication device in a closed position;

FIG. 5 is an exemplary rotatable wireless portable communication device in an opened position;

FIG. 6 is an exemplary slidable wireless portable communication device in a closed position;

FIG. 7 is an exemplary slidable wireless portable communication device in an opened position;

FIG. 8 is an exemplary attachment-ready wireless portable communication device without an attachment;

FIG. 9 is an exemplary attachment-ready wireless portable communication device with an attachment;

FIG. 10 is an exemplary frequency chart showing low and high frequency bands in which the wireless portable communication device may operate;

FIG. 11 is an exemplary block diagram of the ground return impedance block having a plurality of selectable coupling impedances;

FIG. 12 is an exemplary block diagram of the ground return impedance block having a variable impedance device; and

FIG. 13 is an exemplary flowchart describing a process of providing appropriate impedance for a desired antenna performance based upon a configuration of the wireless portable communication device in accordance with the present invention.

### DETAILED DESCRIPTION OF THE PREFERRED EMBODIMENTS

The present invention provides an apparatus and a method for a wireless portable communication device for tuning a ground return impedance based upon a configuration of the wireless portable communication device. The wireless portable communication device detects its configuration, and provides appropriate ground return impedance based upon the detected configuration. The configurations of the wireless portable communication device include various operational aspects of the wireless portable communication device. For example, the operational aspects of the wireless portable communication device may include a physical configuration such as being in an opened position, being in a closed position, or having an accessory attached. Other operational aspects may include a frequency band of operation, a frequency sub-band of operation which is a narrower frequency band within the frequency band, and a mode of operation such as analog, digital, full-duplex, or pseudo-duplex mode of operation. Based upon the detected configuration, the wireless portable communication device adjusts the impedance presented by a ground return impedance block between a ground of a printed circuit board and a chassis to obtain a desired antenna performance. The chassis comprises metal structural components, electrical shields, connectors, circuit board ground planes, or other electrically conductive components of the housing of the wireless portable communication device.

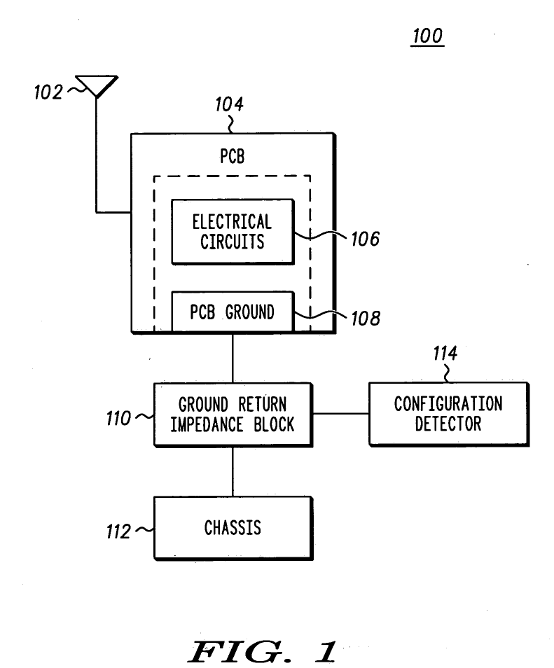

FIG. 1 is an exemplary block diagram of a wireless portable communication device 100 configured to provide appropriate impedance for a desired antenna performance based upon a detected configuration the wireless portable communication device in accordance with at least one embodiment of the present invention. The wireless portable communication device 100 comprises an antenna 102, which is coupled to a printed circuit board 104. The printed circuit board includes electrical circuits 106 for wireless communication and an electrical reference or a printed circuit board ground 108, which is coupled to a ground return impedance block 110. The ground return impedance block 110 is coupled to a chassis 112. A configuration detector 114 is also coupled to the ground return impedance block 110, and is configured to detect a configuration of the wireless portable communication device 100. Based upon the detected configuration of the wireless portable communication device 100 by the configuration detector 114, the ground return impedance block 110 provides appropriate impedance between the printed circuit board ground 108 and the chassis 112 to obtain a desired antenna performance. For example, the configuration detector 114 may generate a control signal indicative of the detected configuration, which then may cause the ground return impedance block 110 to provide an appropriate impedance for the detected configuration.

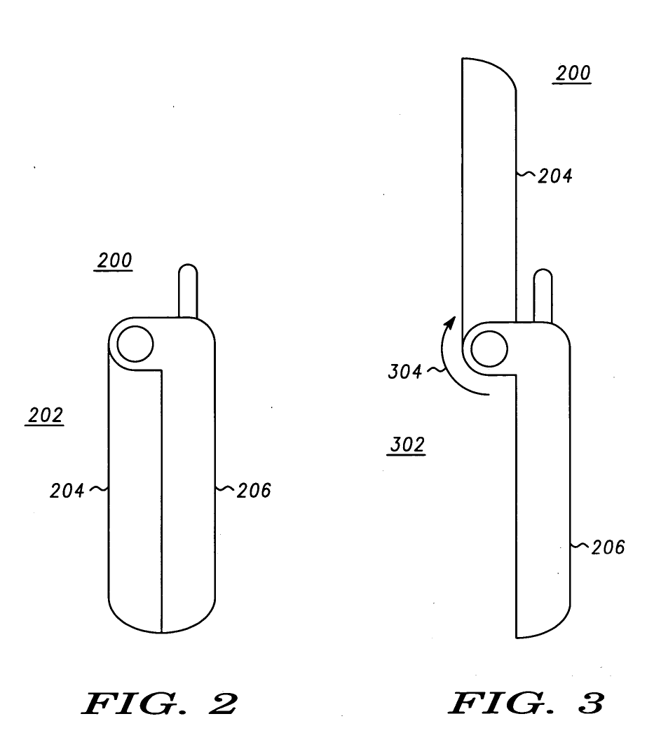

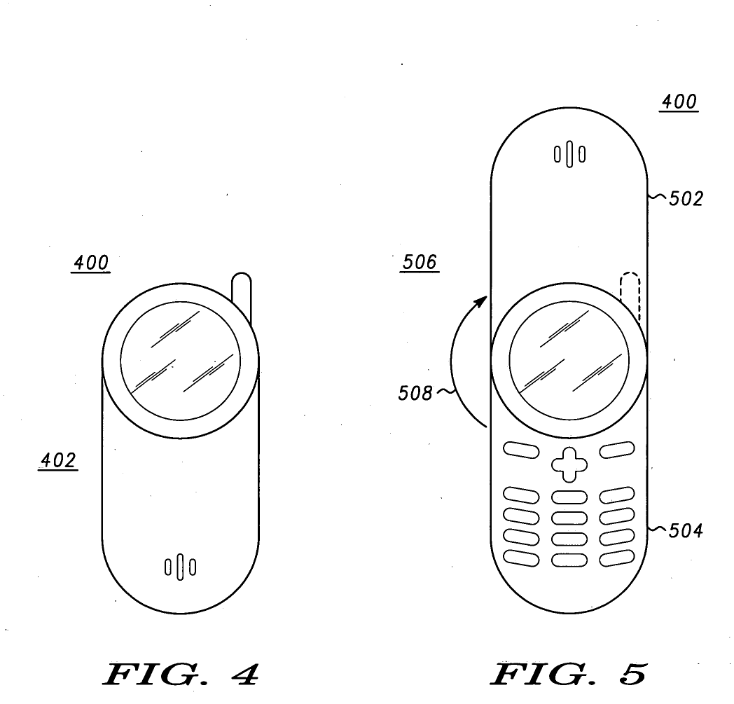

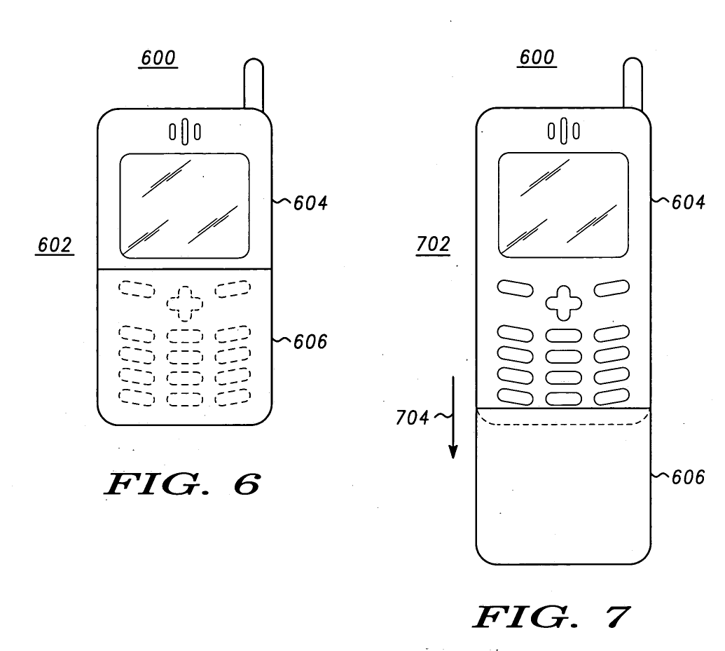

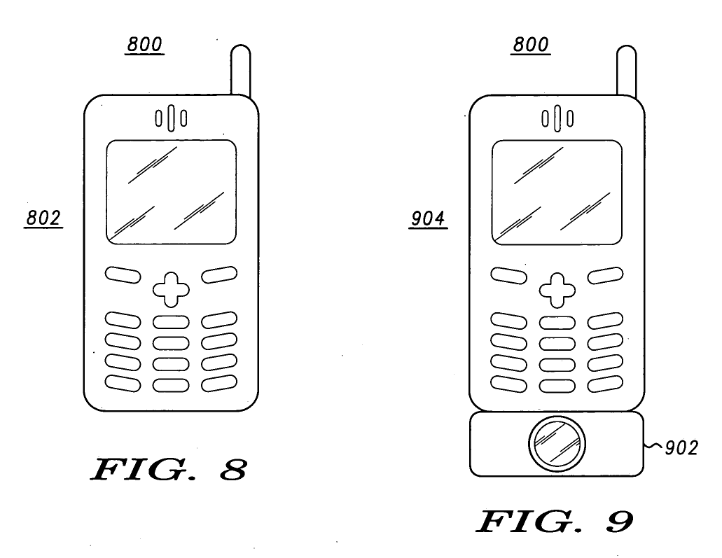

Examples of physical configurations of the wireless portable communication device to be detected are illustrated in FIGS. 2-9. FIG. 2 illustrates a foldable wireless portable communication device 200 shown in a closed position 202, which is one of the configurations to be detected. The foldable wireless portable communication device 200 has a first housing 204 and a second housing 206. As shown in FIG. 3, the foldable wireless portable communication device 200 is opened into the opened position 302, which is another position to be detected, by unfolding the first housing 204 relative to the second housing 206 as indicated by an arrow 304. FIG. 4 illustrates a rotatable wireless portable communication device 400 shown in a closed position 402, which is one of the configurations to be detected. As shown in FIG. 5, the foldable wireless portable communication device 400 has a first housing 502 and a second housing 504, and is opened into the opened position 506, which is another position to be detected, by rotating the first housing 502 relative to the second housing 504 as indicated by an arrow 508. FIG. 6 illustrates a slidable wireless portable communication device 600 shown in a closed position 602, which is one of the configurations to be detected. The slidable wireless portable communication device 600 has a first housing 604 and a second housing 606. As shown in FIG. 7, the slidable wireless portable communication device 600 is opened into the opened position 702, which is another position to be detected, by sliding the second housing 606 relative to the first housing 604 as indicated by an arrow 704. FIG. 8 illustrates an accessory-ready wireless portable communication device 800, which is capable of receiving an attachable accessory, in a stand-alone configuration 802, which is one of the configurations to be detected. As shown in FIG. 9, the accessory-ready wireless portable communication device 800 accepts an attachable accessory 902, and assumes an accessory-attached configuration 904, which is another position to be detected. In general, the positions of any movable or detachable housing pieces may be detected, since these positions may affect the antenna performance.

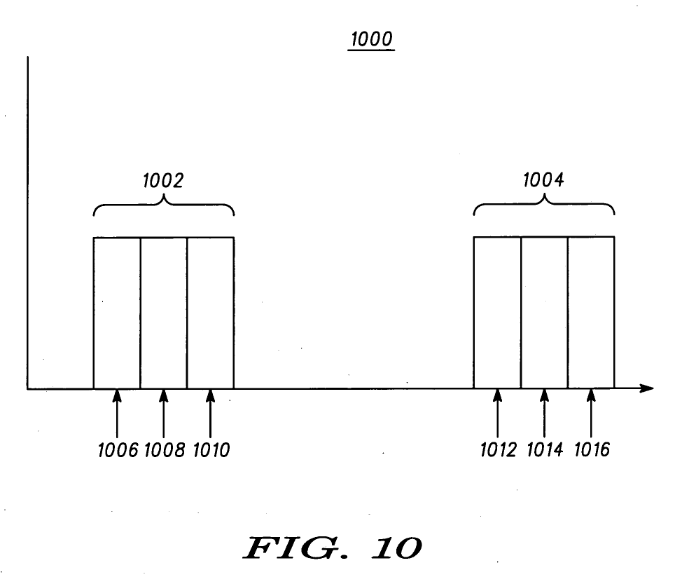

Other examples of configurations to be detected include a frequency band of operation, a frequency sub-band of operation, which is a subdivision of the frequency band, and a mode of operation. FIG. 10 illustrates a frequency chart 1000 showing a low frequency band 1002 and a high frequency band 1004, either of which the wireless portable communication device 100 may operate in. Some of wireless portable communication devices using such frequency bands includes, but are not limited to, a dual band GSM cellular telephone, a dual band/mode GSM-AMPS cellular telephone, a dual band/mode TDMA cellular telephone, and a dual band/mode CDMA cellular telephone. For example, for the dual band GSM cellular telephone, the low frequency band 1002 may represent the 850 MHz and the high frequency band 1004 may represent the 1900 MHz band. For a band/dual mode TDMA cellular telephone, the low frequency band 1002 may represent both the 800 MHz AMPS and TDMA bands and the high frequency band 1004 may represent 1900 MHz TDMA band. The two frequency bands 1002 and 1004 may be further divided into sub-frequency bands; 1006, 1008, and 1010 for the low frequency band 1002, and 1012, 1014, and 1016 for the high frequency band 1004. The mode of operation may include the analog mode such as the AMPS mode and the digital mode such as the GSM, TDMA, and CDMA modes.

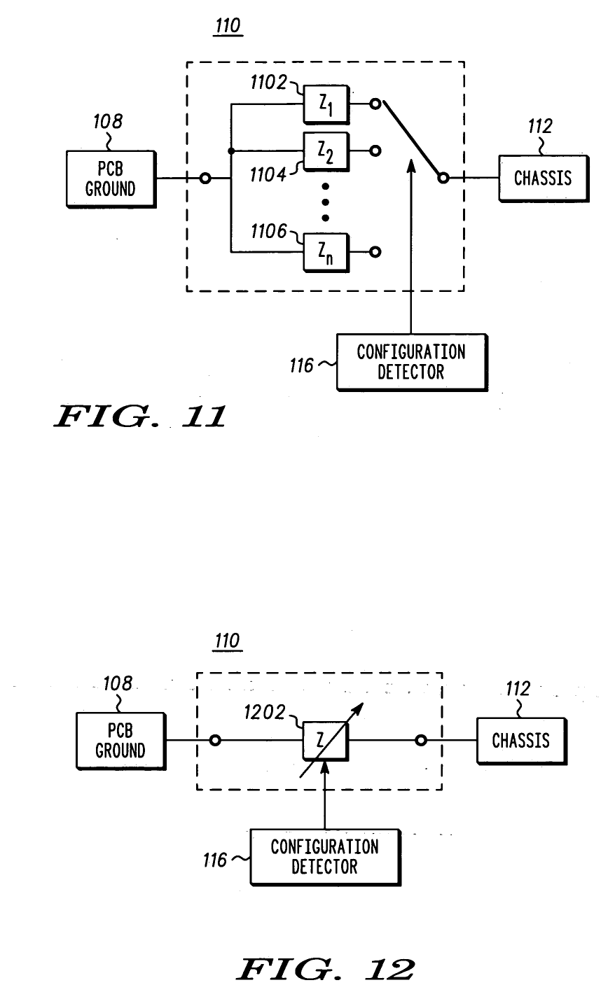

Once the configuration of the wireless portable communication device 100 is detected by the configuration detector 116, the ground return impedance block 110 provides appropriate impedance based upon the detected configuration between the PCB ground 108 and the chassis 112 to obtain the desired antenna performance. As illustrated in FIG. 11, the ground return impedance block 110 may comprise a plurality of selectable impedance sub-blocks (three selectable impedance sub-blocks, 1102, 1104, and 1106 are shown), each of which has a specific impedance that corresponds to a specific configuration of the wireless portable communication device 100. The selectable impedance sub-blocks may be selected by using PIN diodes, multi-gate GaAs-MESFETs, or any other similar devices. Based upon the detected configuration, the configuration detector 114 selects an appropriate selectable impedance sub-block, 1102, 1104, or 1106 of the plurality of selectable impedance sub-blocks that corresponds to the detected configuration.

Using the foldable wireless portable communication device 200 shown in FIGS. 2 and 3 as an example, the ground return impedance block 110 is set up such that the selectable impedance sub-block 1102 corresponds to the closed position 202 and the selectable impedance sub-block 1104 corresponds to the opened position 302. Then upon detecting the configuration of the wireless portable communication device 200 to be in the closed position 202, the configuration detector 114 selects the selectable impedance sub-block 1102 between the PCB ground 108 and the chassis 112. If the configuration of the wireless portable communication device 200 changes to the opened position 302, a user answering an incoming call for example, then the configuration detector 114 detects the configuration to be the opened position 302, and selects the selectable impedance sub-block 1104, which corresponds to the opened position 302, between the PCB ground 108 and the chassis 112. The selection of the appropriate impedance sub-block may be effectuated by using a separate circuit, which is configured to receive an input signal indicative of the detected configuration from the configuration detector 114, and then to produce an output selection signal to the ground return impedance block 110.

The ground return impedance block 110 may comprise one or more variable impedance devices (one variable impedance device 1202 is shown) such as varactors, which are capable of varying impedance. Such variable impedance may be set to a desired impedance value based upon a signal generated by the configuration detector 114. Using again the foldable wireless portable communication device 200 shown in FIGS. 2 and 3 as an example, the configuration detector is set to produce an output signal at a first level for the closed position 202 and at a second level for the opened position 302. The first level is chosen such that the variable impedance device 1202 produces an impedance which is appropriate for the closed position 202 when it receives the first level. Similarly, the second level is chosen such that the variable impedance device 1202 produces an impedance which is appropriate for the opened position 302 when it receives the second level. Then upon detecting that the configuration of the wireless portable communication device 200 is in the closed position 202, the configuration detector 114 produces the output signal at the first level and applies it to the variable impedance device 1202, which then produces impedance appropriate for the closed position 202. If the configuration of the wireless portable communication device 200 changes to the opened position 302, for example a user answering an incoming call, then the configuration detector 114 detects that the configuration is in the opened position 302, and produces the output signal at the second level. The output signal is then applied to the variable impedance device 1202, which then produces an impedance which is appropriate for more optimal performance in the opened position 302. The generation of the output signal applied to the variable impedance device 1202 may be effectuated by using a separate circuit, which is configured to receive an input signal indicative of the detected configuration from the configuration detector 114, and then to produce an output signal at an appropriate level corresponding to the detected configuration to the variable impedance device 1202, which then produces an appropriate impedance for the detected configuration.

As previously illustrated in FIG. 10, the detected configuration may be based upon the frequency band of operation 1002 and 1004, the frequency sub-bands, 1006, 1008, 1010, 1012, 1014, and 1016, or the mode of operation such analog or digital mode. Based upon the detected configuration, the ground return impedance block 110 can similarly provide appropriate impedance between the PCB ground 108 and the chassis 112.

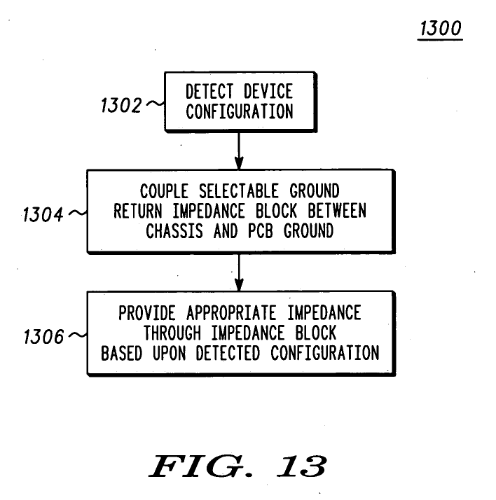

FIG. 13 is an exemplary flowchart 1300 describing a process of providing appropriate impedance for a desired antenna performance based upon a detected configuration of the wireless portable communication device 100 in accordance with at least one embodiment of the present invention. The process 1300 is described below in conjunction with previously described components. The wireless portable communication device 100 has a chassis 114, a PCB ground 108 for electrical circuits for wireless communication, and a selectable ground return impedance block 110 as previously described. The process 1300 begins in block 1302 by detecting the current configuration of the wireless portable communication device 100 by the configuration detector 114. In block 1304, the PCB ground 108 and the chassis 112 is coupled through the selectable ground return impedance block 110. Based upon the detected configuration of the wireless portable communication device 100 in block 1302, the selectable ground return impedance block 110 provides the appropriate impedance to obtain the desired antenna performance for the detected configuration in block 1306. As previously described, the configurations to be detected include a position of the first housing relative to the second housing indicative of being in the closed or opened position, presence of an attached accessory, a frequency band of operation, a frequency sub-band of operation, and a mode of operation. As illustrated in FIGS. 11 and 12, the selectable ground return impedance block 110 may comprise a plurality of selectable impedance sub-blocks, which may be selected by using PIN diodes, multi-gate GaAs-MESFETs, or any other similar devices, or may comprise one or more of variable impedance devices such as varactors.

While the preferred embodiments of the invention have been illustrated and described, it is to be understood that the invention is not so limited. Numerous modifications, changes, variations, substitutions and equivalents will occur to those skilled in the art without departing from the spirit and scope of the present invention as defined by the appended claims.

1. A wireless portable communication device configured to provide appropriate impedance for a desired antenna performance based upon a configuration of the wireless portable communication device, the wireless portable communication device comprising:
a radiating element;
electrical circuits for wireless communication coupled to the radiating element, the electrical circuits including an electrical reference;
a selectable ground return impedance block coupled to the electrical reference, the selectable ground impedance block configured to provide a plurality of impedance values;
a chassis coupled to the selectable ground return impedance block; and
a configuration detector coupled to the selectable ground return impedance block, the configuration detector configured to detect a configuration of the wireless portable communication device and to produce a control signal indicative of the detected configuration which selects one of the plurality of impedance values.

2. The wireless portable communication device of claim 1, wherein the configuration detector is configured to detect at least one of:
a position of a first housing of the wireless portable communication relative to a second housing of the wireless portable communication device, the second housing movably coupled to the first housing,
presence of an attachable accessory attached to the wireless portable communication device,
a frequency band of operation,
a frequency sub-band of operation, wherein the frequency band of operation comprises a plurality of frequency sub-bands of operation; and
a mode of operation.

3. The wireless portable communication device of claim 2, wherein the position of the first housing relative to the second housing includes an opened position of the wireless portable communication device wherein at least one of:
the first housing unfolds relative to the second housing;
the first housing rotates relative to the second housing; and
the first housing slides relative to the second housing.

4. The wireless portable communication device of claim 2, wherein the position of the first housing relative to the second housing includes a closed position of the wireless portable communication device wherein at least one of:
the first housing unfolds relative to the second housing;
the first housing rotates relative to the second housing; and
the first housing slides relative to the second housing.

5. The wireless portable communication device of claim 2, wherein:
the selectable ground return impedance block comprises a plurality of selectable coupling impedances, each of the plurality of selectable coupling impedances corresponding to a specific detectable configuration of the wireless portable communication device, and
the control signal selects one of the plurality of impedance values by selecting an appropriate selectable coupling impedances of the plurality of selectable coupling impedances corresponding to the detected configuration.

6. The wireless portable communication device of claim 2, wherein:
the selectable ground return impedance block comprises a variable impedance device capable of varying impedance, and
the control signal is effective in adjusting the variable impedance device to provide an appropriate impedance corresponding to the detected configuration.

7. A method in a wireless portable communication device for selecting one of a plurality of ground return impedances coupled between a chassis and an electrical reference of electrical circuits for wireless communication for a desired antenna performance, the method comprising:
detecting a configuration of the wireless portable communication device; and
selecting an appropriate impedance of the plurality of ground return impedances based upon the detected configuration.

8. The method of claim 7, wherein detecting a configuration of the wireless portable communication device by detecting at least one of:
a position of a first housing of the wireless portable communication device relative to a second housing of the wireless portable communication device, the second housing movably coupled to the first housing,
presence of an attachable accessory attached to the wireless portable communication device
a frequency band of operation,
a frequency sub-band of operation, wherein the frequency band of operation comprises a plurality of frequency sub-bands of operation; and
a mode of operation.

9. The method of claim 8, further comprising opening the wireless portable communication device before detecting the position of the first housing relative to the second housing by at least one of:
unfolding the first housing relative to the second housing;
rotating the first housing relative to the second housing; and
sliding the first housing relative to the second housing.

10. The method of claim 8, further comprising closing the wireless portable communication device before detecting the position of the first housing relative to the second housing by at least one of:
unfolding the first housing relative to the second housing;
rotating the first housing relative to the second housing; and
sliding the first housing relative to the second housing.

11. The method of claim 7, wherein selecting an appropriate impedance of the plurality of ground return impedances based upon the detected configuration by selecting an appropriate selectable coupling impedance of a plurality of selectable coupling impedances, each selectable coupling impedance corresponding to a specific detected configuration.

12. The method of claim 7, wherein selecting an appropriate impedance of the plurality of ground return impedances based upon the detected configuration by varying the impedance of a variable impedance device corresponding to the detected configuration.

13. An antenna arrangement for a wireless portable communication device having a first housing and a second housing, the first housing movably couple to the second housing, the wireless portable communication device having a closed position and an opened position, each position defined by a relative position of the first housing to the second housing, each position corresponding to one of detectable configurations, the first and second housings coupled to a configuration detector, the antenna arrangement configured to provide a desired antenna performance based upon a detected configuration of the wireless portable communication device, the antenna arrangement comprising:
an antenna;
an electrical reference coupled to the antenna;
a selectable ground return impedance block coupled to the electrical reference and to the configuration detector, the selectable ground return impedance block adapted to receive a control signal indicative of the detected configuration of the wireless portable communication device from the configuration detector, the selectable ground return impedance block adapted to provide an appropriate impedance based upon the control signal; and
a chassis coupled to the selectable ground return impedance block.

14. The antenna arrangement of claim 13, wherein the configuration detector is further adapted to detect at least one of:
presence of an attachable accessory attached to the wireless portable communication device,
a frequency band of operation,
a frequency sub-band of operation, wherein the frequency band of operation comprises a plurality of frequency sub-bands of operation; and
a mode of operation.

15. The antenna arrangement of claim 14, wherein the opened position of the wireless portable communication device includes at least one of:
the first housing is configured to unfold relative to the second housing;
the first housing is configured to rotate relative to the second housing; and
the first housing is configured to slide relative to the second housing.

16. The antenna arrangement of claim 14, wherein the closed position of the wireless portable communication device includes at least one of:
the first housing is configured to unfold relative to the second housing;
the first housing is configured to rotate relative to the second housing; and
the first housing is configured to slide relative to the second housing.

17. The antenna arrangement of claim 13, wherein:
the selectable ground return impedance block comprises a plurality of selectable coupling impedances, each of the plurality of selectable coupling impedances corresponding to a specific detectable configuration of the wireless portable communication device.

18. The antenna arrangement of claim 13, wherein:
the selectable ground return impedance block comprises a variable impedance device capable of varying impedance.
